(19) United States
(12) Patent Application Publication
(10) Pub. No.: US 2016/0029626 A1
(43) Pub. Date: Feb. 4, 2016

(54) CYSTEINE AMINO-ACID COMPOUND (OR ITS ANALOGUES) USED IN THE DISRUPTION OF MICROBIAL BIOFILMS WHEN TREATING OR PREVENTING DISEASES CAUSED BY PHYTOPATHOGENIC BACTERIA KNOWN TO ATTACK PLANTS OF AGRICULTURAL INTEREST

(71) Applicants: Alessandra ALVES DE SOUZA, Cordeiropolis (BR); Helvecio DELLA COLETTA FILHO, Cordeiropolis (BR); Marco Aurelio TAKITA, Araras (BR); Marcos Antonio MACHADO, Campinas (BR); Ligia SEGATTO MURANAKA, Rio Claro (BR)

(72) Inventors: Alessandra ALVES DE SOUZA, Cordeiropolis (BR); Helvecio DELLA COLETTA FILHO, Cordeiropolis (BR); Marco Aurelio TAKITA, Araras (BR); Marcos Antonio MACHADO, Campinas (BR); Ligia SEGATTO MURANAKA, Rio Claro (BR)

(73) Assignee: INSTITUTO AGRONOMICO DE CAMPINAS - IAC, Campinas - Sao Paulo (BR)

(21) Appl. No.: 14/792,298

(22) Filed: Jul. 6, 2015

Related U.S. Application Data
(62) Division of application No. 14/009,053, filed on Sep. 30, 2013, now abandoned.

(30) Foreign Application Priority Data
Mar. 31, 2011 (BR) PI 1101176-9

(51) Int. Cl. A01N 37/46; A01G 7/06

(52) U.S. Cl. CPC A01N 37/46; A01G 7/06

(57) ABSTRACT

“Cysteine amino-acid compound (or its analogues) used in the disruption of microbial biofilms by treatment of prevention of diseases generated by phytopathogenic bacteria attacking plants of agricultural interest” represented by an innovative solution within the agriculture sector, where said compound can be used in the pharmacological form, as a drug associated with fertilizer for the combat of bacterial diseases which form microbial biofilms, such as citrus variegated chlorosis (CVC), citric canker', huanlongbing (HLB) disease or ‘greening’, amongst other, which inventive concept, as such, never before completed, resides in the benefit deriving from the cysteine amino-acid, and all of its analogues, in the inhibitory action and progressive disruption of the microbial biofilm thus liberating the nutritive flux and hydration of the root to the upper part of the plant and the subsequent regression of the disease symptoms, with the added advantage that the cysteine amino-acid compound is non-toxic, guaranteeing healthy production of foods by plants of agricultural interest that are totally healthy, without toxic residues in their composition, as well as when said compound is applied there is risk to the environment due to the rapid absorption, notably within the area in which it is applied, where such predicates of disease combat, with the exception of toxic collateral effects still guarantee that the final crop and harvest will have a higher productivity per hectare.

### CROSS REFERENCE TO RELATED APPLICATIONS

This application is a Divisional of co-pending application Ser. No. 14/009,053, filed on 30 Sep. 2013, and for which priority is claimed under 35 U.S.C. §120, which claims priority of PCT Application No. PCT/BR2012/000003, filed on 9 Jan. 2012, which claims priority to Application No. PI 1101176-9 filed in Brazil on 21 Mar. 2011, the entire contents of all of which are hereby incorporated by reference.

### AREA OF APPLICATION

This invention patent, title of which is contained in the above heading, is the object of this description and claims of this title concerns an inventive solution found to be highly beneficial in the agricultural sector, with a broad spectrum of application, especially in the cultivation of different types of plants of agricultural interest, helping to minimize “loss of productivity” and even “crop failure”, deriving from the harmful effects of pathogenic plant bacteria which, once established in the plant, promote biofilm formation whose action converges and interrupts the flow of water and nutrients from roots to plant shoots.

Broadly speaking, the “Cysteine amino-acid compound (or its analogues) used in the disruption of microbial biofilms when treating or preventing diseases caused by phytopathogenic bacteria known to attack plants of agricultural interest” can be used alone or bound to another compound, such as copper or zinc, to act in the disruption of microbial biofilms that cause general disease in plants, notably highlighted below:

1. Application in citrus plants: as a guide for the developing this new “Cysteine amino-acid compound (or its analogues) used in the disruption of microbial biofilms when treating or preventing diseases caused by phytopathogenic bacteria known to attack plants of agricultural interest”, the applicant adopted the economic recovery of the citrus plant when attacked by citrus variegated chlorosis (CVC), “citrus canker”, huanglongbing disease (HLB) or “greening”, amongst others.

1a. “CVC” disease: the applicant sees the use of “Cysteine amino-acid compound (or its analogues) used in the disruption of microbial biofilms when treating or preventing diseases caused by phytopathogenic bacteria known to attack plants of agricultural interest” as a means to reversal of symptoms and the consequent economic recovery of the affected plant from a disease technically known as citrus variegated chlorosis (CVC), which is caused by the bacterium “Xylella fastidiosa (X. fastidiosa)” which forms a microbial biofilm and in turn leads to blockage of the xylem vessels of the citrus plant, thus impeding the subsequent recovery of citrus plants.

1b. “Citrus canker” disease: the applicant envisions the use of the “Cysteine amino-acid compound (or its analogues) used in the disruption of microbial biofilms when treating or preventing diseases caused by phytopathogenic bacteria known to attack plants of agricultural interest” as an adjuvant for the subsequent application of copper on the citrus plant leaves, in order to combat another disease known as “citrus canker”, caused by the bacterium Xanthomonas citri pv. citri;

1c. Huanglongbing (HLB) disease: the applicant envisages “Cysteine amino-acid compound (or its analogues) used in the disruption of microbial biofilms when treating or preventing diseases caused by phytopathogenic bacteria known to attack plants of agricultural interest” being applied to control the disease known as huanglongbing (HLB) or “greening”, which is a globally occurring citrus disease (except in Mediterranean countries), aiming to disrupt bacterial clusters in the phloem of affected citrus plants;

2. Application in coffee and prune plants: both are benefitted by the use of the unique “Cysteine amino-acid compound (or its analogues) used in the disruption of microbial biofilms when treating or preventing diseases caused by phytopathogenic bacteria known to attack plants of agricultural interest”, because they are also affected by strains of the “X. fastidiosa” bacteria which causes the atrophy of the plum tree and coffee plant branches, associated with leaf scalding;

3. Application in vine plants: the “Cysteine amino-acid compound (or its analogues) used in the disruption of microbial biofilms when treating or preventing diseases caused by phytopathogenic bacteria known to attack plants of agricultural interest” can benefit the cultivation of vines in the United States whose primary disease (Pierce's disease) is also caused by the bacterium X. fastidiosa.

Finally, it is possible to affirm that “Cysteine amino-acid compound (or its analogues) used in the disruption of microbial biofilms when treating or preventing diseases caused by phytopathogenic bacteria known to attack plants of agricultural interest” can benefit the treatment of almost all plants used as natural hosts by pathogenic bacteria (especially strains of the bacterium X. fastidiosa), thus benefitting crops such as alfalfa, plum, peach and almond, amongst numerous other natural hosts (see Hopkins & Purcell, Plant Disease, 86, 1056-1066, 2002).

### DEMAND FOR THIS INVENTION

Of the economic potential for citrus cultivation: the citrus agro-business is present in more than 50% of municipal towns in the State of Sao Paulo, it generates both economic growth and jobs. In the State of Sao Paulo alone, this activity accounts for approximately 400,000 direct and indirect jobs, generates 1.5 billion dollars from the export of concentrated and un-concentrated (frozen) juice and by-products (refer to http://www.abecitrus.com.br).

The State of São Paulo is the largest citrus cultivator in Brazil with a citrus plantation of approximately 200 million trees, which together with the ‘Minas Triangle’ accounts for 84% of the production of sweet oranges in the country (Brazil), according to data from the Institute of Agricultural Economics (IEA).

Of productivity in citrus management: even though one of the world's leading citrus exporters, Brazil still has a citrus productivity considered as being very low (80.4 kg of fruit per tree) given the potential for cultivation. This low productivity is associated with, among other factors, the existence of pests and diseases and is significantly reflected in production costs. One of the main biotic factors limiting the production of citrus in Sao Paulo is Citrus Variegated Chlorosis (CVC), a disease caused by the bacterium Xylella fastidiosa.

The survey data of said disease (Citrus Variegated Chlorosis [CVC]) (2009) conducted by the Foundation for the Defense of Citrus Cultivation (Fundecitrus) in the State of Sao Paulo showed that approximately 50% of the citrus orchards in the North, West and Central State regions presented symptoms of the disease. This ratio increased dramatically in the South (from 4.7 to 20%), a region which, prior to the study, was not considered as suffering a major CVC problem.

According to these statistics table, estimates of economic damage caused by Citrus Variegated Chlorosis (CVC) are of the order of 286-322 million dollars annually (Fernandes, 2003), in the form of replanting, pruning of infected plants and vector control. Furthermore, when symptoms are severe and the plant is up to 3 years of age, it is necessary to eradicate the trees, thus causing lack of uniformity in the Orchard. If this problem is combated by replanting, the new shoots consequently increase the difficulties of pyrotechnical plant management, thus leading to more costs.

Of productivity when managing other crops: although the data disclosed above are exclusive to agribusiness activity pertaining to citrus, it is clear that other crops such as coffee, for example, have greatly compromised their productivity because they presented diseases similar to Citrus Variegated Chlorosis (CVC), or more specifically, diseases which attack the plant by bacterial action forming microbial biofilms that impede the flow of water and nutrients from the root to the shoot of the plant.

Of the Identified Demand:

1. From the point of view of agribusiness: considering the facts presented, it is a fact that demand for this invention in the form of “Cysteine amino-acid compound (or its analogues) used in the disruption of microbial biofilms when treating or preventing diseases caused by phytopathogenic bacteria known to attack plants of agricultural interest” is to forcefully leverage the productivity of the cultivation of all sorts of plants contributing to the supply of the supply of foods to the world population, which is growing at exponential rates.

2. From the point of view of the consumer: to ensure that food products derive from crops containing only healthy material, i.e., minimize the presence of pesticides, or at least the portion of toxicity stemming from the use of pesticides applied as treatment and prevention of phytopathogenic diseases such as Citrus Variegated Chlorosis (CVC), citrus canker, Huanglongbing disease (HLB) or “Greening”, Pierce's disease, among many others that attack all sorts of agricultural crops.

In sum, the agribusiness needs to technologically equip farmers in order to allow provision of food in conditions ideal for consumption (proven to be healthy) and affordable to all strata of the planet's population,

### REQUIREMENTS OF THE INVENTION

In accordance with the demand for such an invention, the applicant devised a ground breaking new method of use of a product “Cysteine Amino-Acid Compound (or its Analogues) Used in the Disruption of Microbial Biofilms when Treating or Preventing Diseases Caused by Phytopathogenic Bacteria Known to Attack Plants of Agricultural Interest” used in the disruption of microbial biofilms in the treatment or prevention of diseases generated by bacterial phytopathogens that affect plants of agricultural interest” which is equipped with a new and innovative activity, in that it does not obviously or evidently follow on from other solutions or known techniques concerning the resolution of the problem of loss of productivity in agricultural crops, neither does it negatively affect the health of the individual who consumes food coming from agricultural produce treated by the invention.

In addition, the “invention” has effective industrial applicability, in that it is economically viable, given the rigorous requirements of patentability, notably as a patent for invention, as provided in the dictates of Articles 8 and 13 of Law 9.279.

### TECHNICAL BACKGROUND

In order to provide accuracy and consolidate the context presented in the topics of the above introduction, an explanation will be offered concerning current techniques that have been developed and are broadly used as solutions in the treatment of diseases which attack plantation crops in general, but not being the final objective of this study, the explanation of fertilizing products, which does not make invalid the possibility for the unique application of the “Cysteine Amino-Acid Compound (or its Analogues) Used in the Disruption of Microbial Biofilms when Treating or Preventing Diseases Caused by Phytopathogenic Bacteria Known to Attack Plants of Agricultural Interest” in the configuration of this type of product use offered by the agribusiness.

Of the Cultivation of Agricultural Food Crops:

1a. Organic products: are an alternative to the use of any procedure involving the genetic modification of plants as well as discarding the use of any chemical products such as agro toxins, in the combat against pests and diseases, as such it is considered an ideal solution.

1b. Identified Problem: although products of organic origin are a consumer trend globally, specifically in the developed world, it is a fact that this type of product does not provide crops that are distinguished by high productivity, precisely because the organic plant is vulnerable to the action of pests and disease, thus forcing high costs on crops and a limited scale of production, reflected directly on the high final price for the consumer.

2a. Of genetically modified products: as evidenced in the topic of demand for the invention, the agribusiness sector has developed a number of solutions to increase the productivity of various plant crops, one of which is the genetic improvement of the plant itself, which generates increased productivity per hectare planted and still further creates resistance within the plant against the action generated by pests, insects and even bacteria, such resistance has not been previously observed in non-modified plants.

2b. Problem identified: critical analysis of this type of solution refers to the real fact that although there are significant results in productivity gains and plant quality, there is still much public resistance to the final product generated, notably in the international community, since there is no conclusive study proving genetically modified plants do not bring some kind of danger to consumer health (both human and animals).

Corrective treatments against the action of pests and diseases: the agricultural industry provides countless products, presented as “drugs” or “medicines” in a liquid state (for spraying) or solid state (powders, granules, etc. . . . ) that aim to combat pests or diseases that attack crops, among which the following are most widely used:

1a. Agro-products: also known as agricultural pesticides or agrochemicals, they are products composed of a chemical formulation, used to exterminate pests or diseases that cause damage to crops. There are several types of pesticides, among which the ones that stand out are those acting on weeds (herbicides) and insects (insecticides).

Other classes of pesticide are also known, such as fungicides, a pesticide that destroys or inhibits the action of fungi which attack plants in general. The use of synthetic fungicides is very common in conventional agriculture;

1b. Problem identified: Although agro products provide effective eradication of pests and diseases and lead to increased productivity of all sorts of agricultural crops, it is a fact that this type of solution brings with it the negative aspect of toxicity that is added to the final food product obtained, given that part of the agrichemical applied to the plant is absorbed by the same.

In addition, the part of the agrichemical that is not absorbed by the plant is absorbed by the soil and is in turn washed away by rainfall and deposited in water reservoirs, such as effluents from rivers and lakes, thus contaminating them.

Lastly, although the use of I.P.E (Individual Protective Equipment) when handling agrochemicals is widespread and indeed now required by law, there is always the possibility of contamination of the individual who applies it.

2a. Antibiotic products: also known as “bactericide” agents, these are compounds that destroy the bacterial cell wall or protein synthesis, thus eliminating bacteria. Still further in this product range, are antibiotics known as “bacteriostatic” that simply prevent bacterial growth.

2b. Problem identified: although antibacterial products also have efficacy in the eradication of diseases and ensure productivity that makes food economically viable, there is a negative aspect to their use; the brevity of the effect obtained, because bacteria quickly create resistance to antibiotics, making the repetitive use of the same bactericide unviable. In turn, the biofilm has several advantages for colonies of bacteria, among which the colonies becoming more resistant to antimicrobial agents, making the combat of bacterial illnesses requiring high doses of antimicrobial agents.

Preventative Action of Pests and Diseases:

1a. Prevention procedures: although agro-toxins and antibiotic bactericidal products are widely developed by the agribusiness (data points to about 15,000 formulations of 400 different agrochemicals, according to the site www.wikipedia.com, keyword: agrichemical), there is a wide variety of plants to which these “chemicals” do not apply, some of which are citrus plants, coffee, vines, plum, peach, almond and alfalfa crops, among others, where the condition common to these plant crops lies in the fact that all are naturally prey to bacterial diseases, notably by strains of the bacterium X. fastidiosa that uses them as a host (see Hopkins Purcell, Plant Disease, 86, 1056-1066, 2002).

As with the case of plants that are affected by diseases of a bacterial nature, such as strains of the bacterium X. fastidiosa and Xanthomonas citri pv. citri, among others, nothing more remains for the farmer to do but take preventive measures, which are translated in the form of a technological management package, which includes procedures such as:
Pruning of branches showing symptoms of the disease in the leaves as well as the complete eradication of severely affected plants;
Control of the insect bacteria vector, by using agrichemical insecticides;
Use of seedlings with a phytosanitary certificate insomuch as being produced in an environment protected from vectors. This system, adopted by law in the State of Sao Paulo from 2003, is directed towards the activity of citrus cultivation.

1b. Identified Problem: although this represents a breakthrough in the treatment of diseases caused by bacterial action, this treatment is a stopgap control procedure, in that it imposes economic damage on the farmer which stems from the need to eliminate very sick plants, as well as the fact that this practice (pruning) provokes new and vigorous shoots, in themselves attractive to another disease vector, that of HLB. Lastly, the use of agrichemical insecticides to eliminate the insect vector of bacterial phytopathogens causes damage to the ecosystem and an environmental imbalance in plantations, with the subsequent emergence of secondary pests.

### PROPOSAL OF THE INVENTION

The applicant, being aware of the gap that exists in the treatment of diseases in plants of agricultural interest, especially diseases of bacterial origin and even more so those that involve strains of the bacteria “X. fastidiosa”, proceeded to develop an innovative solution in the form of a “Cysteine Amino-Acid Compound (or its Analogues) Used in the Disruption of Microbial Biofilms when Treating or Preventing Diseases Caused by Phytopathogenic Bacteria Known to Attack Plants of Agricultural Interest”, which can be prepared individually or bound with another compound and be applied to plants diseased by bacterial pathogens.

Understanding plant diseases caused by the formation of bacterial biofilms: as a source of study and in order to develop this invention, the applicant elected the action of bacterial phytopathogens on plant structure, made use of scientific data that translates this action into the generating a microbial biofilm, which in turn leads to the blockage of the plant's xylem vessels and prevents the flow of nutrients and water from the root to the shoot of the plant.

Of the Invention's Objectives:

a. Provide corrective action: to develop a method of use of a product (a drug, for example) which, once applied to the plant suffering from bacterial disease, acts so as to gradually destroy the microbial biofilm and free the flow of nutrition and hydration from the root to the shoot of the plant, resulting in the subsequent regression of disease symptoms;

b. Provide preventive action: a method of use of a product (a drug, for example), can also be used in a preventive manner, i.e. even in plants without the presence of the disease and its symptoms;

c. Develop a method of use of a product (a drug, for example) that once applied to the plant does not, at the end of the crop harvest, result in food containing toxic waste and/or modified genetic material, ensuring the integrity of consumer health (both of humans and animals);

d. Develop a method of use of a product, (a drug, for example) that once applied to the plant, does not, at the end of the crop harvest, result in differing conditions of productivity per hectare.

Of the development paradigm: in order for the objectives outlined for this invention to be considered feasible, the applicant has elected to use mucolytic agents that act by deforming the bacterial biofilm in particular, by using the cysteine amino acid, and its entire spectrum of analogues.

These mucolytic agents include cysteine (L-cysteine, D-cysteine, DL-cysteine), and their analogues and derivatives such as:
DL-Homocysteine;
L-cysteine methyl ester;
L-cysteine ethyl ester;
N-carbamoyl cysteine, cisteamine;
N-(2-mercaptoisobutiril)-L-cysteine;
N-(2-mercaptopropionil)-L-cysteine-A;
N-(2-mercaptopropionil)-L-cysteine-B;
N-(3-mercaptopropionil)-L-cysteine;
L-cysteine ethyl ester hydrochloride;
L-cysteine methyl ester hydrochloride;
nacistelina (a lysine salt of N-acetylcysteine);
N-acetylcysteine (NAC); and
S-carbometil cysteine (carbocisteine).

One of the best-known mucolytic agents is N-acetyl L-cysteine (NAC) which hydrolyses the disulphide bridges in cysteine residues of the bacterial protein phytopathogens, thereby undermining the biofilm. For this reason this agent was elected by the applicant to consolidate a preferred format in which the “cysteine amino-acid compound analogues”, as an object of prolonged explanation in the section detailing the invention.

Of the criteria involved in the choice: for the definition of the choice of “cysteine amino acid (or its analogues)” in the development of the method of use of the compound invented, the applicant defined the following as product requirements: margin of safety for the consumer; margin of safety for the environment and economic feasibility of the product. This framework can be evidenced in the following:

1. Margin of safety for the consumer: by electing the “mucolytic agents” that act by disrupting the bacterial biofilm, and specifically “cysteine amino acid (or its analogues)”, the applicant assures the requirement of non-toxicity of the product either when applied to the plant affected by diseases originating from plant pathogenic bacteria, or when present and incorporated into the food waste generated by it. This is consolidated by concrete fact in that the “cysteine amino acid,” especially the analogous agent N Acetyl-L-cysteine (NAC) has for many years been used in the composition of “active mucolytic drugs” used by human adults and children, and in this procedure is widely held as being completely legal, according to regulations of competent organs such as ANVI10 SA. The applicant has consulted all toxicity tests conducted extensively and repeatedly on humans and animals regarding this.

To consolidate the statement made in the preceding paragraph, the applicant highlights the use of an agent analogous to cysteine amino acid, N-acetyl L-cysteine (NAC) that is used in animal drugs for the treatment of congestive and obstructive pulmonary diseases associated with hyper secretion of mucus, such as chronic bronchitis and cystic fibrosis, and paracetamol intoxication. In such cases, the N-acetyl L-cysteine (NAC) acts as a mucolytic agent. But this use has also been reported to reduce the adhesion of human pathogenic bacteria such as Streptococcus epidermidis, and Haemophilus influenzae, Moraxella catarrhalis in epithelial cells (Zheng et al., 1999) and surface abiotic (OLOFSSON et al., 2003). Parry et al. (1976), and in addition demonstrated efficiency of the NAC compound regarding the adhesion of Peseudomonas aeruginosa, Klebsiella pneumoniae Enterobacter cloacae, and Staphylococcus aureus.

These studies demonstrate the wide influence of N-acetyl L-cysteine (NAC) on biofilm formation, both in Gram positive and Gram-negative human pathogenic bacteria; a fact that inspired the applicant to use said agent in the inhibition of biofilms present in plants of agricultural interest and similarly affected by bacterial diseases.

2. Safety margin regarding the environment: one of the features of “Cysteine amino-acid compound (or its analogues) used in the disruption of microbial biofilms when treating or preventing diseases caused by phytopathogenic bacteria known to attack plants of agricultural interest” lies in the fact that they are easy to absorb and their environmental half-life is demonstrably short, which means the substance does not present a risk of having a negative environmental impact;

3. Economic viability: from the point of view of the agribusiness, the applicant consolidated knowledge that industrial-scale production of “Cysteine amino-acid compound (or its analogues) used in the disruption of microbial biofilms when treating or preventing diseases caused by phytopathogenic bacteria known to attack plants of agricultural interest”, in various forms of presentation is anchored to low costs, or in other words, shall be readily accessible for both large and small scale farm producers.

Consolidation of inventive activity: In consulting several patent banks, some were found to hold patent applications related to possible applications of the N-acetyl cysteine L-cysteine (NAC) analogue in the area of pharmacology, where it is renowned for its role as an antioxidant and in the treatment of aging.

In turn, research conducted on the (esp@cenet) database identified patent application KR20080007474 (A) dated 21 Jan. 2008, but careful reading of this text highlights the use of cysteine NAC analogue starch as an antioxidant able to make plants more resistant to oxidative stress caused by biotic and abiotic factors.

As can be seen from the above, none of the documents cited present an inventive concept that anticipates the subject matter of this present claim of exclusive use, which in turn and as a distinguishing feature of, brings in its wake the fact that the “Cysteine amino-acid compound (or its analogues) used in the disruption of microbial biofilms when treating or preventing diseases caused by phytopathogenic bacteria known to attack plants of agricultural interest” act decisively in the disruption of microbial biofilms generated by plant pathogenic bacteria, thus ensuring the unique condition and service requirement of an inventive action, which is an unpublished, innovative prevention or treatment of diseases in plants of agricultural interest affected by the action of plant pathogenic bacteria. This is something that until now has never been tried, using a non-toxic product that is easily absorbed and of a proven short half-life in the environment for prevention or treatment of plants.

In addition to “Cysteine amino-acid compound (or its analogues) used in the disruption of microbial biofilms when treating or preventing diseases caused by phytopathogenic bacteria known to attack plants of agricultural interest” inhibiting biofilm formation, it appears to be toxic to the cells of phytopathogenic bacteria, especially for the bacterium X. fastidiosa in vitro, because there was a significant decrease in cell mass and the number of living cells, when compared to the control group, to which the substance was not added. (Experimental data, in vitro).

Of the product presentation format: the unique “Cysteine amino-acid compound (or its analogues) used in the disruption of microbial biofilms when treating or preventing diseases caused by phytopathogenic bacteria known to attack plants of agricultural interest” may be offered to farmers in five different forms of presentation, of which is highlighted the encapsulated form, which offers the benefit of ensuring a gradual release of cysteine, and therefore accompanying the development of the plant in most parts of its development cycle of agricultural interest and thus reducing the need for any reapplication of this innovative method of use of this compound.

Of the mode of application: the action of “Cysteine amino-acid compound (or its analogues) used in the disruption of microbial biofilms when treating or preventing diseases caused by phytopathogenic bacteria known to attack plants of agricultural interest” in the prevention or treatment of the plant is anchored to its application to soil in the form of a fertigation “drench” (flooding a small area near the plant) or alternatively applied as a fertilizer in encapsulated form, which leads to slow absorption, in which the “cysteine compound” could be absorbed by the roots and taken to the xylem of plants and then commence the action of disintegration of the microbial biofilm.

In addition, the applicant also foresees the seasonal “Cysteine amino-acid compound (or its analogues) used in the disruption of microbial biofilms when treating or preventing diseases caused by phytopathogenic bacteria known to attack plants of agricultural interest” to diminish the presence of X. fastidiosa in the plant, being duly applied during periods of increased likelihood of the spread of bacteria by the vector, since symptoms may recur when treatment is stopped.

The applicant also foresees the possibility of using “Cysteine amino-acid compound (or its analogues) used in the disruption of microbial biofilms when treating or preventing diseases caused by phytopathogenic bacteria known to attack plants of agricultural interest” associated with zinc (which is a micro-nutrient commonly applied in the cultivation of plants of agricultural interest) and thus enhancing the antimicrobial capacity of the invented compound.

### BRIEF DESCRIPTION OF THE DRAWINGS

To complement this description of the specification and in order to obtain a better understanding of the characteristics of this patent, attached is a set of charts and tables which are not, however, intended to limit the scope of the invention, being limited only to the explicit set of claims, where:

FIG. 1. is a representation of the model of the mode of action of NAC in vivo;

FIG. 2. Is an illustrative representation of derivation of the reaction of NPM with NAC;

FIG. 3 is a representation of the quantification of cell mass formed during treatment after the addition of 1 mg/mL, 2 mg/mL and 6 mg/mL of NAC and control (without addition of compound). The different letters indicate a statistically significant difference of 5% probability.

FIG. 4 is a qualitative illustrative representation of cellular plant mass formed after an additional 1 mg/ml, 2 mg/mL and 6 mg/mL of NAC and control (without addition of composite). The different letters indicate a statistically significant difference of 5% probability;

FIG. 5 is a representation of the number of viable cells of biofilm X. fastidiosa subjected to 1 mg/mL, 2 mg/mL and 6 mg/mL of NAC compared with the control situation (without addition) of the compound. Different letters indicate that there was a statistically significant difference level of 5% probability;

FIG. 6 is a representation of the curve pattern for quantification of EPS (mg/L) drawn up by the measurement of different concentrations of glucose. From this default curve it is possible to understand the OD correlation (optical density) measured in spectrophotometer with the amount of EPS in the sample;

FIG. 7 is a representation of the quantification of EPS in the biofilm of X. fastidiosa subjected to 1 mg/mL, 2 mg/mL and 6 mg per mL NAC in comparison with the situation control (without addition of the compound). Different letters indicate that there was a significant statistical difference to the level of 5% probability;

FIG. 8 is a representation of the standard curve for quantifying cells of X. fastidiosa;

FIG. 9 is a representation of the number of bacterial cells quantified by qPCR in samples subjected to different treatments in experiment 1;

FIG. 10 is a representation of the number of bacterial cells quantified by qPCR in samples of different treatments of experiment 2.

FIG. 11 is a representation of the standard curve of NAC. The curve relates the concentration of the sample in μg/mL, along the x-axis, to the value of the area of the peaks relating to the NAC presented in the chromatogram, on the Y axis.

FIG. 12 is a representation of the chromatogram showing the lowest concentration used for preparation of the curve, compared with the highest concentration. The first peak refers to the product derived from NAC-NPM and the second, to the remaining NPM.

FIG. 13 is a graphical representation of the chromatogram of experiment samples regarding environmental degradation of NAC after 1, 7 and 14 days. The first peak refers to the product derived from NAC-NPM and second, to the remaining NPM.

### DETAILED DESCRIPTION

The following detailed description must be read and interpreted with reference to the drawings, graphs and tables presented. It represents the preferred forms of the unique method of use of the compound cysteine amino-acid, used in the disruption of microbial biofilms during the treatment or prevention of disease generated by bacterial pathogens that affect plants of agricultural interest, during which a comprehensive study conducted on laboratory scale, and choosing the analogue of cysteine known as N-acetyl L-cysteine (NAC). It is not intended to limit the scope of the invention, rather limiting merely the claims described in the referred table.

First tests were performed in vitro to investigate the possible effects of N-acetyl L-cysteine (NAC) on X. fastidiosa biofilms. After obtaining these results, field experiments were performed on orange pear plants with CVC symptoms. For all experiments we used the 9a5c strain, re-isolated in the PW (Davis et al., 1981) of sweet orange pear plants with CVC symptoms and kept under nets. An inoculum of bacteria was made using freshly isolated cells from the host plant (isolated first in the PW) and allowed to grow in a defined medium XDM₂ (Lemos et al., 2003) at 29° C. with a speed of 130 rpm. The cells were kept in this condition for 6 to 7 days to obtain the optical density (OD) of 0.3, equivalent to a population of 10 8 CFU/mL.

Experiments In Vitro:

In order to evaluate the effect of N-acetyl L-cysteine (NAC) on X. fastidiosa biofilm in vitro, we used different concentrations of the compound; 1 mg/mL, 2 mg/mL and 6 mg/mL. The middle pH of the culture was adjusted with NaOH 1M after the addition of different doses of the cysteine N-acetyl L-cysteine analogue (NAC). Three mL of inoculum and 18 mL of medium XDM² were placed in glass Erlenmeyer flasks for growth of biofilm on the liquid-air surface, as well as the different concentrations of N-acetyl L-cysteine (NAC). After 14 days of biofilm growth, which is the time it takes to reach the stage of maximum cell density, analyses were performed. Controls without the addition of the compound were also used. The cell mass of biofilms formed on the surface of liquid-air in each Erlenmeyer was quantified by the Crystal Violet method described by Espinosa-Urgell et al., (2000). The collected biofilms were washed with water and 1 mL of crystal violet 0.1% was added. After 5 minutes many more washes were performed using water. 1 mL of 100% ethanol was added and the absorbance of the sample measured at 590 nm. Statistical analysis was performed using the t test (P<0.05) with the Assistat 7.3 beta software program (http://assistat.sites.uol.com.br). Three biological repetitions were performed. The same procedures and analysis were also performed on the recovered cells, after centrifuging for precipitation of the pellet, of the culture medium remaining in each and erlenmeyer. These remaining cells in suspension culture represent the planktonic fraction.

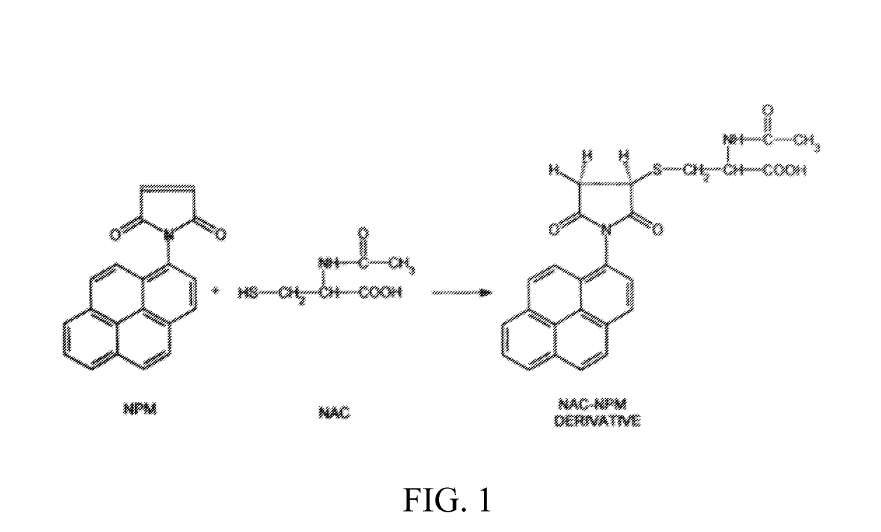

The cell mass of biofilms subjected to different doses of NAC was reduced compared to the control condition (see FIG. 1). Note that the largest decrease in cell mass occurred at the highest dose of N-acetyl L-cysteine (NAC), 6 mg/mL, reaching a reduction of approximately 100%.

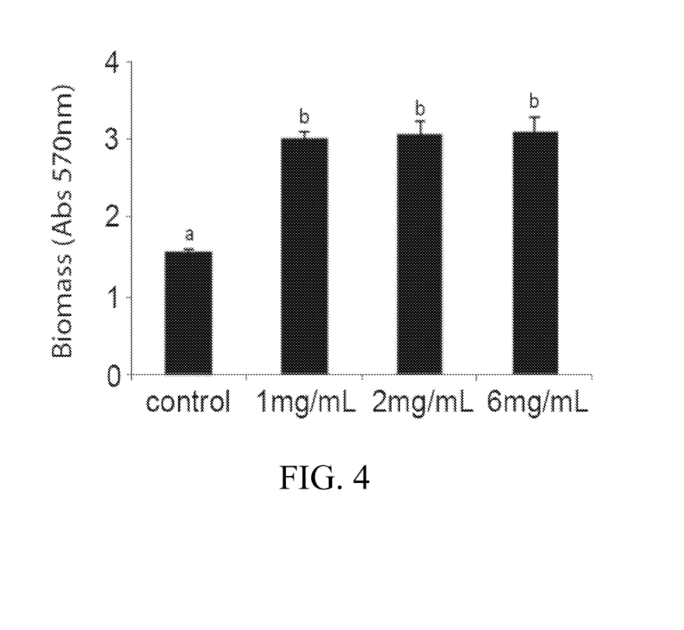

Already, the quantification of cell mass of planktonic cells present in each Erlenmeyer shows an increase in mass when they were added to the different doses of NAC (see FIG. 4).

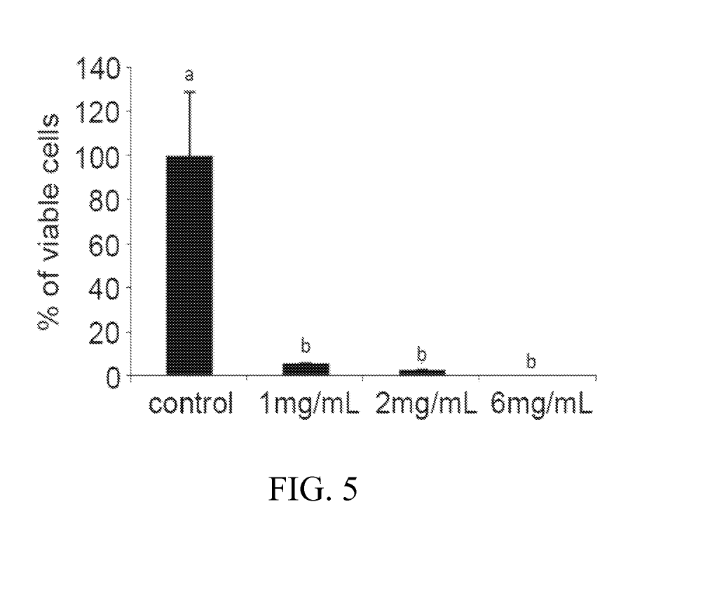

With cell mass determination however, living and dead cells are quantified, so even if there is a large value of 10 cell mass, this could in theory be composed of only dead cells. With the serial dilution and count of the number of colonies, the number of living cells present in the samples is estimated. The number of colony forming units (CFU) of bacteria in biofilm cells in the presence of different concentrations of N-acetyl L-cysteine (NAC) was evaluated after the serial dilution of three biological replicates and three plates per replicate. Controls without addition of N-acetyl L-cysteine (NAC) were also evaluated. The same procedures and analysis were also conducted with the fraction of planktonic cells present in suspension in the culture medium in each Erlenmeyer. However, after centrifugation of the culture medium remaining in each erlenmeyer, in order to facilitate the recovery of planktonic cells, they were washed 3 times with milli-Q water by repeated pipetting before serial dilution of the same. This procedure was adopted in an attempt to eliminate any residue of N-acetyl L-cysteine (NAC), and thus the possibility of any substance acting only as a bacteriostatic agent. For treatment with 6 mg/mL of N-acetyl L-cysteine (NAC) the number of living cells present in the biofilm was reduced by almost 100% (see FIG. 5), which agrees with the results of cell mass.

From the results of cell viability and cell mass obtained it was possible to observe that N-acetyl L-cysteine (NAC) has 1 mg/mL concentration, it was possible to inhibit the growth of bacteria, since the quantification of CFU/mL was lower than in the control biofilm.

With respect to serial dilutions of planktonic cells, what we noticed was the opposite of what happened with the results of cell mass. Despite this having risen in various experiments with N-acetyl L-cysteine (NAC), it was found that the cells in suspension were dead, since in serial dilution it was not possible to count any CFU (data not shown). In the control experiment, it was possible to count large numbers of cells, which shows that in control, although most cells are forming the biofilm, you can also find them in the planktonic phase.

Still further, exopolysacchride (EPS) totals of each sample were quantified using the phenol-sulphuric acid method described by Dubois et al (1956). The standard curve was prepared using different concentrations of glucose and statistical analysis was performed by t test (P<0.05) with the Assistat 7.3 beta software program (http://assistat.sites.uol.com.br). Three biological replicates were performed with 6 measurements per repetition.

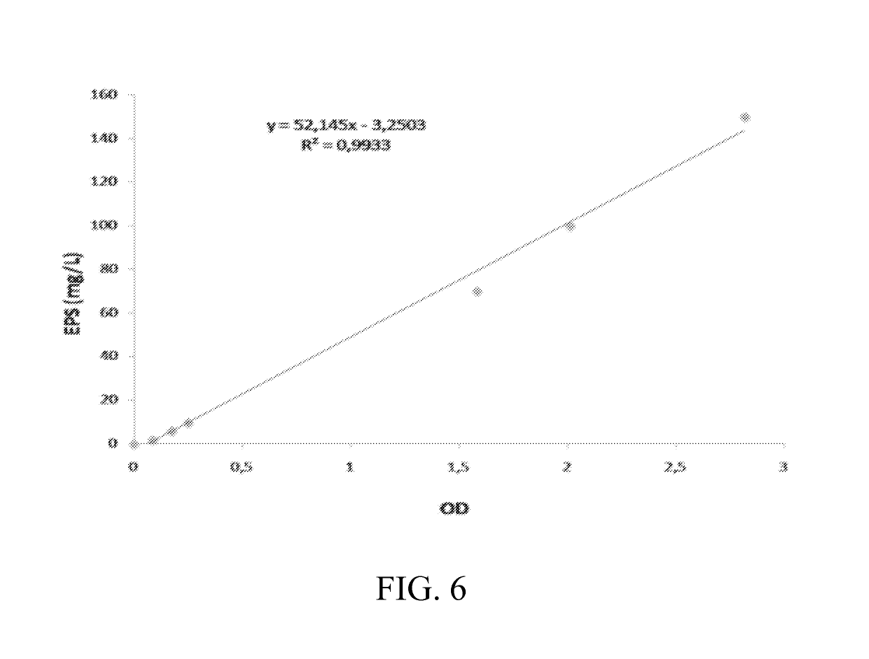

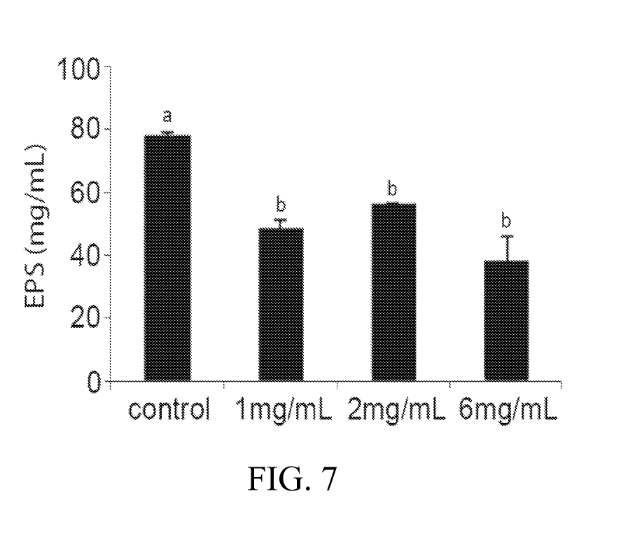

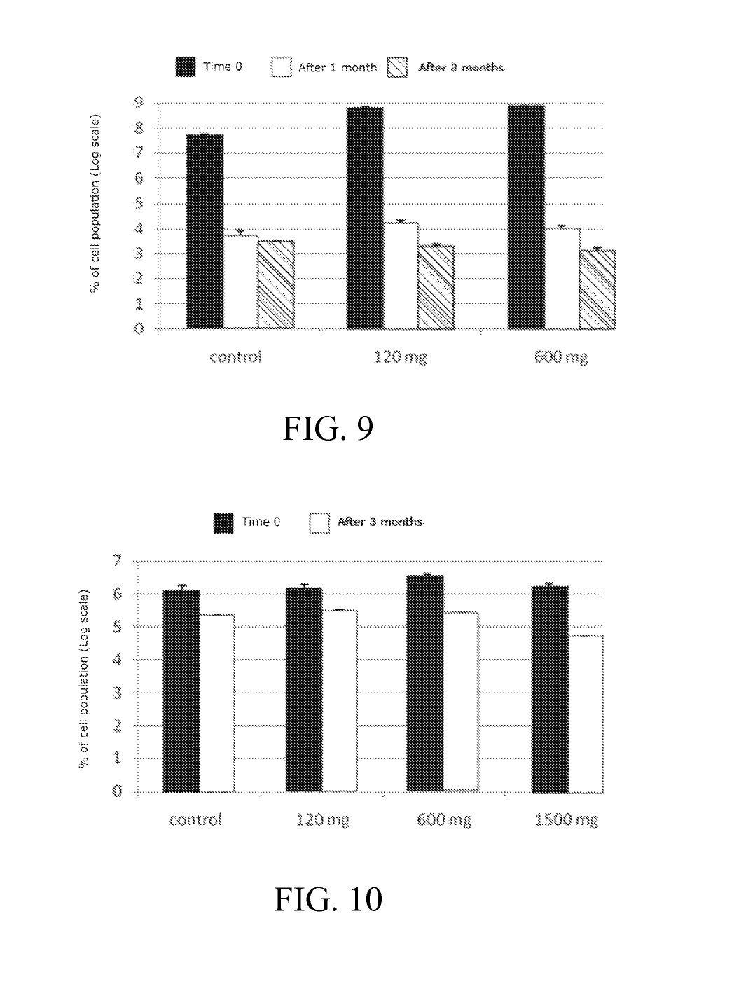

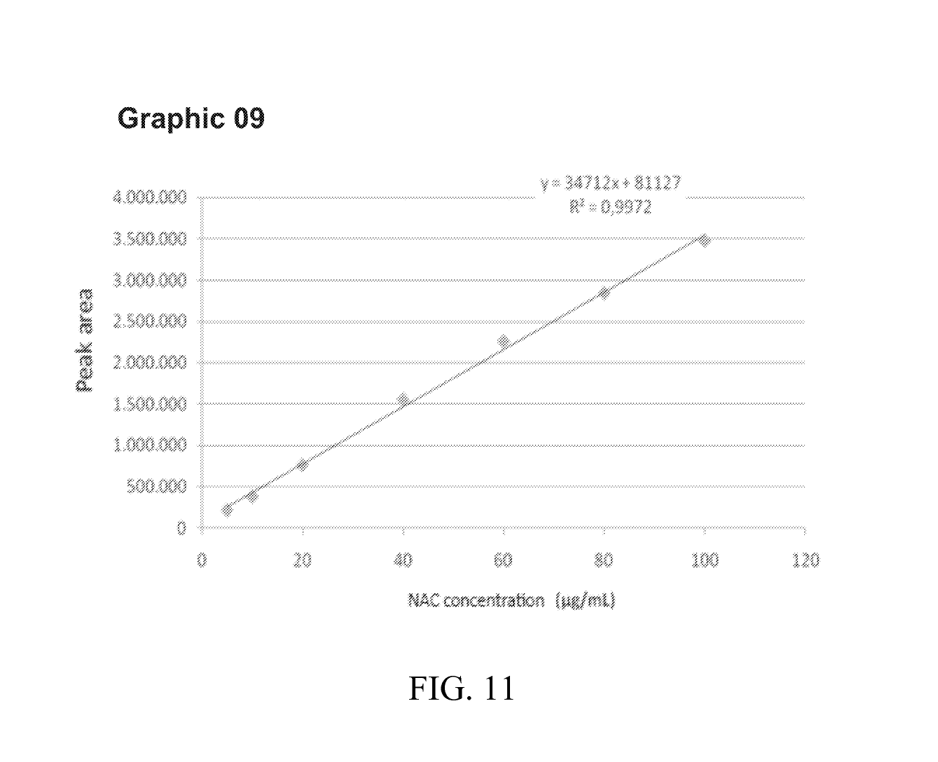

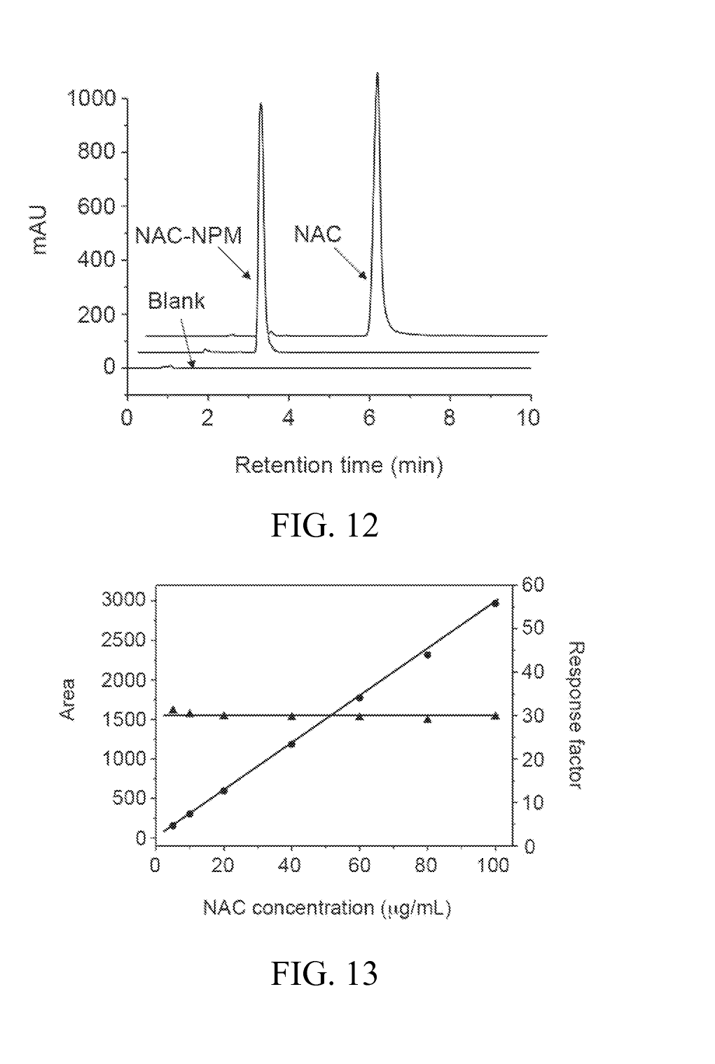

Linear regression (y=52.145x−3.2503) of the curve drawn with known concentrations of glucose was used for the calculation of EPS in mg/L (see FIG. 6). In control, the total amount of EPS was greater in relation to treatment with N-acetyl L-cysteine (NAC), as can be viewed in FIG. 9.

According to the Crystal Violet experiments, the cell mass of the biofilm when subjected to different doses of N-acetyl L-cysteine (NAC) was lower, reaching to about 100% with 6 mg/mL of N-acetyl L-cysteine (NAC). But the lowering of EPS observed between the control and when 6 mg/ml of N-acetyl L-cysteine (NAC) was added, for example, was only about 45%, thus the average production of EPS per cell probably increased, which could be an attempt by the bacteria to hinder the penetration of N-acetyl L-cysteine (NAC) in the biofilm. Induction of EPS as a mechanism of response to antimicrobial compounds has been reported as a means of increasing bacterial resistance (Wai et al, 1998).

The results obtained in this study, also suggest the possible toxic action of N-acetyl L-cysteine (NAC) for bacterial cells, which, through the studies using serial dilutions of biofilm samples for counting CFU (colony-forming units) we were unable to verify minor or no growth of bacteria when subjected to treatment with N-acetyl L-cysteine (NAC).

This result could be explained by a bacteriostatic action of N-acetyl L-cysteine (NAC) or a toxic effect that would result in cell death of the bacteria. The bacteriostatic effect hypothesis was discarded since new serial dilution experiments were carried out after 3 washes with water (to remove any residue of NAC) and the growth of the cells continued to be observed. Moreover, in an in vitro situation, in which there are neither defense responses of the infected plant, nor strong pressure of xylem flow, and available nutrients exist in the culture medium, if the action of the molecule was only the disintegration of the biofilm, this alone would not form but the cells could continue living in planktonic form, but did not.

Thus, it can be assumed that N-acetyl L-cysteine (NAC) has toxic action towards X. fastidiosa cells. Risii and collaborators (1999) also cite a possible toxic effect of N-acetyl L-cysteine (NAC).

As the N-acetyl L-cysteine (NAC) proved to be a promising molecule for the control of biofilm X. fastidiosa in vitro, studies were performed on orange pear plants with symptoms of citrus variegated chlorosis disease (CVC). These plants were treated with different doses of N-acetyl L-cysteine (NAC). The following tests were performed:

1. Of the plants' symptoms: visual comparison of plant foliage, without any treatment (control plants) and with the addition of different doses of N-acetyl L-cysteine (NAC).

2. Isolation of bacteria: to obtain an estimate of the number of bacteria present in each sample of the plants (with the different treatments using N-acetyl L-cysteine (NAC) and untreated control plants).

3. Isolation of bacteria: because with the qPCR technique, living and dead bacteria can be quantified. However, with the isolation technique only live bacteria grow on plates with culture specific medium of X. fastidiosa.

4. Analysis of N-acetyl L-cysteine (NAC) by HPLC: a method for quantification of the substance by HPLC was developed. Using this method, it was possible to quantify the initial amount (concentration) of N-acetyl L-cysteine (NAC) used for each treatment after one day in the presence of the plant. This analysis was performed in order to investigate if the substance was being transferred by the plant and thus enable potential differential results obtained from previous studies be associated with the presence of N-acetyl L-cysteine (NAC).

Following on this descriptive topic, a description of the procedures performed for each analysis.

Experiments In Vivo:

1. Transmission of the CVC in orange pear plants infected into healthy seedlings: citrus variegated chlorosis (CVC) was transmitted to healthy orange pear seedlings (Citrus sinenses) using the techniques of grafting and fork grafting. Using the grafting technique, a segment of the stem of an orange pear plant with symptoms of CVC (plant source) was cut and placed in contact with a healthy shoot (receiving plant), the area of contact between the exchanges being approximately 5 cm. In the technique of fork grafting, a piece of detached branch (fork) of the plant source was juxtaposed onto the healthy shoot after which the region was tied and covered with plastic tape used in grafting work. The shoots were kept in tubes with an irrigation system and under nets. After 30 days of inoculation, the plants were evaluated through the sampling of leaves collected above the region of grafting and fork grafting. We performed the extraction of total DNA for molecular detection of X. fastidiosa via conventional PCR using primers specific for X. fastidiosa citrus (CVC1/272-2 int) (Hartung & Pooler, 1995). The seedlings with positive diagnosis for the presence of the bacteria were then used for the experiments with NAC.

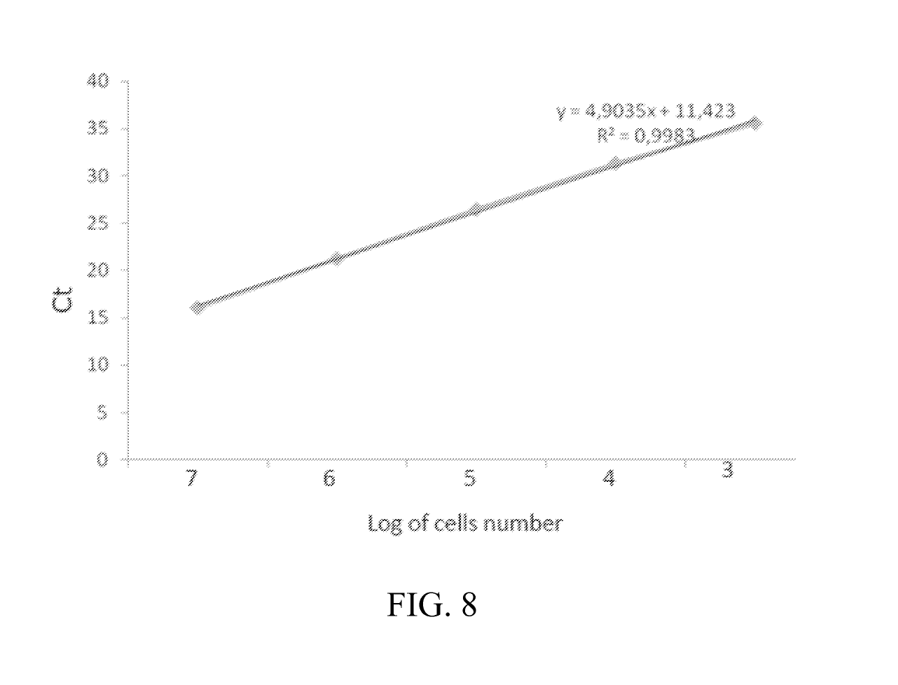

2. Experiments using NAC on infected plants: An analysis was performed with quantitative PCR, as described in sequence, to quantify the initial population of bacteria in plants. The plants were then transferred to Leonard pots, constructed from 750 mL glass bottles, cut and painted with metallic paint to prevent light penetration. Previously autoclaved, vermiculite and sand were added to the top of the vessel and in the collecting part, a Hoagland Arnon (1950) nutrient solution (FIG. 8). Two experiments were performed with different doses of N-acetyl L-cysteine (NAC), both conducted in a greenhouse (see table 1 below).

TABLE 1
Summary of the analyses carried out in each
of the experiments performed in vivo.

| | | Experiment | |
|---|---|---|---|
| Analysis | | 1 | 2 |
| Doses of NAC used | | 120 and | 120, |
| | | 600 mg | 600 and |
| | | | 1500 mg |
| Quantification of bacteria | Zero Time | Yes | Yes |
| per qPCR | After 1 month | Yes | No |
| | After 3 months | Yes | Yes |

| | | |
|---|---|---|
| Quantification of NAC per HPLC | Yes | Yes |
| Isolation of the bacteria after 3 months' treatment | No | Yes |
| Visual evaluation of leaf symptoms | Yes | Yes |
| Visual evaluation of symptoms after interruption of | No | Yes |
| treatment with NAC | | |

The first of the experiments was a pilot, in which 120 mg and 600 mg of N-acetyl L -cysteine (NAC) were added to 250 mL of Hoagland & Arnon (1950). Control plants were also maintained without addition of N-acetyl L-cysteine (NAC). The second test had plants to which were added 120 mg, 600 mg and 1500 mg L30 N-acetyl cysteine (NAC) along with 250 mL of nutrient solution of Hoagland & Arnon (1950) and control experiments without the addition of the compound. 4 biological repetitions were performed for each treatment in each experiment.

3. Collection of samples for HPLC and real-time quantitative PCR (qPCR): samples for HPLC analysis were collected from the nutrient solution present in the collecting vessel. The remaining solution was discarded. The samples were placed in freezer at −80° c. for later analysis. In the first experiment, after 30 and 90 days of treatment, randomly chosen leaves from each plant were collected. In the second experiment, the first leaves just above the grafted/fork grafted point were collected, but only after 90 days of treatment with N-acetyl L-cysteine (NAC). The DNA was extracted using the INVITEK kit (Invisorb Spin Plant Mini Kit) for quantification of the bacteria by qPCR.

After the last 90 days of collection with treatment to the seedlings of the second experiment, they were planted and remained in the greenhouse for evaluation of plant development and symptoms after discontinuation of treatment with N-acetyl L-cysteine (NAC).

4. CVC symptoms in plants: in the early in vivo experiments when treatment with NAC had not yet been started, all the plants showed typical symptoms of CVC, as shown in FIG. 9. The amount of bacterial cells present in the samples collected from each plant was determined by qPCR and is presented in the following topic. After 3 months of treatment with N-acetyl cysteine (NAC) in both experiments, visible reduction of symptoms in the leaves was evident when compared to the leaves collected after 2 months of interrupted treatment in which the plants were kept in a greenhouse and planted in soil (samples coming from experiment 2).

In the control group, without treatment with N-acetyl L-cysteine (NAC), a greater number of leaves were displayed with chlorosis and spots of necrotic lesions, in addition to the incidence of symptoms per leaf also being greater.

Furthermore, in treatments with 120 and 600 mg N-acetyl L-cysteine (NAC) it was still possible to see some points chlorosis in the leaves, but in smaller quantities.

The disease was more severe on plants that had not received treatment with N-acetyl L-cysteine (NAC). In the plants that received 1500 mg of N-acetyl L-cysteine (NAC), it was hardly possible to see symptoms, but plant development was clearly affected. The leaves appeared wilted and of a yellow coloration, indicating a lack of micronutrients, and the identification of typical symptoms of CVC was delayed, similar to the effects described above are provided by the PEG, an agent capable of inducing osmotic stress in plants. After 2 months in soil, those plants returned to sprout and grow.

After 2 months of cultivation in soil, and without treatment with N-acetyl L-cysteine (NAC), it was possible to verify that the plants that had not been treated with N-acetyl L-cysteine (NAC) as the CVC symptoms were more severe. The chlorosis spots occupied most of the leaves, causing more severe injuries. In addition, the leaves showing the symptoms of disease were greater in plants without treatment with N-acetyl L-cysteine (NAC).

In the plants exposed to 120 and 600 mg of N-acetyl L-cysteine (NAC), even after two months without treatment, symptoms were observed to be less severe. Plants that were subjected to treatment with 1500 mg of N-acetyl L-cysteine (NAC) remained less developed; however, multiple shoots were observed. The leaves were usually smaller and of a lighter color, indicating new leaves. In the same, chlorosis spots were not observed.

5. Absolute quantification of the bacterial population by qPCR: for absolute quantification it was necessary to first establish a standard curve (see FIG. 6). To this end, DNA was extracted from X. fastidiosa and the number of cells present in the sample determined accordingly. The following reasoning was used: a strand of DNA from X. fastidiosa has 2679310pb, which was multiplied by 660 Daltons, which is related to the molecular weight of two nucleotide bases. The Daltons were then converted to nanograms (ng) and the number of cells in each sample calculated. The extraction and calculation of the amount of cells present in each sample of DNA from leaves of healthy Orange Pear was also performed. A serial dilution of a DNA sample from X. fastidiosa was performed with a predetermined number of cells as described previously. This dilution was mixed with a sample of DNA from healthy orange pear leaves.

DNA extracted from the leaves of plants submitted to different treatments with N-acetyl L-cysteine (NAC) was quantified by spectrophotometer and amounts were standardized. The samples were then analyzed by qPCR on sylvatica using the 7500 ABI (Applied Biosystems) apparatus.

After elaborating the curve, the number of bacterial cells in each sample was calculated, plotting the Ct value of each sample in the previously generated standard curve. The average number of cells of X. fastidiosa in each sample of experiment 1 can be viewed in graph 7 and from experiment 2, in chart 8. Zero time refers to the first gathering of leaves of plants before the start of treatment with N-acetyl L-cysteine (NAC) and the times 1 and 3 concern collections carried out after 1 and 3 months of treatment.

From the results of experiment 1, it is possible to affirm a significant difference between the number of bacterial cells quantified 1 or 3 months after treatment with N-acetyl Lcisteina (NAC), so in experiment 2 analyses were conducted only after 3 months of treatment. During the three months of the experiment, a decrease in the initial number of bacteria in plants was observed, regardless of treatment assessed, even in control, and in general, the amount of bacteria in each plant does not appear to have been affected by the presence of N-acetyl L-cysteine (NAC).

6. Isolation of bacteria of leaf petioles through serial dilution: as bacteria quantified through the qPCR technique could have been already dead, isolation was enforced, through serial dilution, on samples of the second experiment after 3 months of treatment with N-acetyl L-cysteine (NAC). For this, the main rib of each leaf petiole was sterilized, sliced and mashed together with 1 mL of PBS buffer. 100 mL of buffer containing parts of macerated leaves were removed and a serial dilution of the sample was performed. Each dilution was placed on plates containing a medium of solid PW with BSA (bovine serum albumin) (Davis et al., 1981). The following dilutions of all samples were plated: 10-1, 10-2, 10-3 and 10-4. After 30 days, the numbers of colony-forming units (CFU) were counted.

For the plants of experiment 2, the isolation of bacteria present in samples of leaves was also performed on samples collected after 3 months of treatment with N-acetyl L-cysteine (NAC). For some repetitions of the treatment no colony can be observed, even after 30 days of isolation; as evidenced by table 2).

TABLE 2
Number of cfu/mL in each sample of experiment 2.

| | | |
|---|---|---|
| I | Control | —a |
| II | Control | 2.6E+06 |
| III | Control | 2.58E+05 |
| IV | Control | 2.96E+05 |
| I | 120 mg | 9E+04 |
| II | 120 mg | —a |
| III | 120 mg | —a |
| IV | 120 mg | —a |
| I | 600 mg | 3E+04 |
| II | 600 mg | —a |
| III | 600 mg | —a |
| IV | 600 mg | 4.8E+04 |
| I | 1500 mg | 5E+04 |
| II | 1500 mg | 6E+03 |
| III | 1500 mg | 2E+04 |
| IV | 1500 mg | —a |

ano growth in culture medium

Inability to determine the number of colonies can be caused by the non-presence of living cells in the samples collected from plants, or caused by the technique of isolation. However, as all procedures were conducted on the same day, with the same solutions and by the same person, there is a strong indication that the non-detection of cells would be due to the non-presence (or death), or severe reduction of bacteria in the plant. Through the data obtained, it is possible to observe a decrease in the number of X. fastidiosa cells after treatment with N-acetyl L-cysteine (NAC). Moreover, for samples where it was possible to determine the CFU number, the data resulting from the technique were conducive to those found using qPCR.

7. Quantification of NAC by HPLC: for the development of a quantification method of N-acetyl L-cysteine (NAC) a chromatograph of Agilent, Modular Series 1200 was used, with a (G1322A) gas extractor, Quaternary pump (DE62964634), auto-injector (DE64766244), column oven (DE63072817) and UV-Vis (DE 7161511). The chromatograms were registered using EZCrom software. The chromatographic separation was carried out in reverse mode, using an octadecylsilane Elution analytical column (C18) Luna® (II) Phenomenex® (250×4.6 mm, 5 μm, 100A -Torrance, Calif., U.S.A), bound to a security column (Pre-column) using a bi-split HOLDER® cartridge containing in its interior, a C18 security cartridge (4×3 mm, 5 μm, 100 Å) also acquired from Phenomenex®. The derivation of N-acetil L-cysteine (NAC) was carried out with N-(1-pyrenyl) metoxipoli (npm) as suggested by Wu et al. (2006), see FIG. 1.

Subsequently, the limit of detection calculated was 20 to 1.5 μg/mL and the limit of quantification was of 4.5 μg/mL. The limit of quantification is below the first point of the curve (5 μg/mL) which shows that the N-acetyl L-cysteine (NAC) curve generated is appropriate.

Intraday and interday precision checking was performed. To do so, 3 concentrations of N-acetyl L-cysteine (NAC) were evaluated: low (corresponding to 120% of the first concentration of analytic curve) of 6 μg/mL, average (41.67% of the highest concentration of analytic curve) of 50 μg/mL, and high (90% of the largest concentration of analytic curve) of 90 μg/mL. The intraday precision and accuracy was evaluated through quintuplicate analysis of their solutions on the same day and the interday under the same conditions was obtained through analyses made on 3 non-consecutive days. As the coefficients of variation measured for precision and accuracy tests were below 2.0, which is the maximum allowable value, the method developed for quantification of N-acetyl L-cysteine (NAC) proved to be precise, accurate and robust. From this curve, the concentration of N-acetyl L-cysteine (NAC) present in each sample collected from the gatherer of Leonard vessels could then be determined, such as evidenced in table 3.

TABLE 3
Quantification of NAC in the samples collected

| Total NAC* | Expected CONC. | Measured Conc | Desv Pad |
|---|---|---|---|
| 120 mg | 0.48 mg/mL | 0.288 mg/mL | 0.0811 |
| 600 mg | 2.4 mg/mL | 1.98 mg/mL | 0.4577 |
| 1500 mg | 6.0 mg/mL | 6.156 mg/mL | 0.1818 |

*Total quantity of NAC added in each treatment
** Concentration of NAC calculated by dividing the total quantity of NAC by 250 mL of nutrient solution.

A study to check the degradation of N-acetyl L-cysteine (NAC) was also performed in a Hoagland nutrient solution under the same conditions in which the in vivo experiment was carried out. The nutrient solution of Hoagland was prepared and placed in the receiving party of potted Leonard (without plants), as well as 600 mg N-acetyl L-cysteine (NAC). Leonard pots were kept in the greenhouse and after 1, 7 and 14 days, samples for quantification of N-acetyl L-cysteine (NAC) by HPLC were collected. After derivatisation and sample analysis it was expected to obtain 187.5 mg/mL (750 mg/mL divided by 4, the dilution factor of the sample during the derivatisation reaction of NAC had it not suffered any degradation, however after 1 day the concentration of N-acetyl L-cysteine (NAC) was 143.14 mg/mL and after 7 and 14 days, it decreased to 63.22 mg/mL and 3.15 mg/mL, respectively (see FIG. 31). The degradation of the substance did not follow a standard rate, however this may be attributed to different average daily temperatures, as during the weeks of the experiments the temperature fluctuation was high during the day.

Thus, the in vivo experiments also pointed to N-acetyl-L-cysteine (NAC) being a promising molecule for the control of biofilm X. fastidiosa. Symptoms of CVC were visibly smaller when the plants were subjected to treatment with N-acetyl cysteine (NAC). Moreover, the results obtained by the isolation of X. fastidiosa in a culture medium showed a strong decrease of bacteria in plants subjected to treatment with N-acetyl L-cysteine (NAC). With the use of the HPLC technique it was also possible to ascertain that the N-acetyl L-cysteine (NAC) could be transported by the plant, since the merger measures of the compound were below those expected, and thus reached the xylem vessels affected by the bacteria. However, with the addition of 1500 mg of N-acetyl L-cysteine (NAC) the absorption of the substance by the plant does not occur. The addition of a high concentration of N-acetyl L-cysteine (NAC) (1500 mg in 250 mL of the nutrient solution) was possibly responsible for causing a saline (osmotic) stress in plants, which in turn would enable some mechanisms to avoid it. Visually, the amount of Hoagland absorbed by these plants was very low, which we believe to be responsible for the wilting of leaves and lower physiological development of the plants, since the plant also suffered water stress.

With 1500 mg of N-acetyl L-cysteine (NAC), despite the HPLC technique showing that the substance was not being absorbed by the plant, there was a decrease in the number of visible symptoms and bacteria in the samples of the leaves. We can associate this decrease in the number of bacteria and symptoms to osmotic stress, which in turn caused water stress in the plant. The great stress suffered by the plant from the high concentration of NAC (1500 mg in 250 mL) caused a fall of leaves, wilting and visible damage to the physiological development of the plant, so this might be an explanation as to why the number of quantified bacteria subsided. With the lower doses (120 and 600 mg) N-acetyl L-cysteine (NAC), a greater decrease of symptoms and number of bacterial cells in the samples of the leaves was also observed, but plants presented expected physiological conditions for their age and growth conditions. Thus, these doses of N-acetyl L-cysteine (NAC) were effective in controlling the bacterium and do not cause problems for plant development.

From the evidence obtained from the decrease in visual symptoms in plants subjected to treatment with N-acetyl L-cysteine (NAC), we believe that the substance is actually being transported through the conducting vessels of raw sap, however, the concentration that is actually presented to the bacteria might be much less than expected.

On the basis of data obtained through experiments carried out on plants, we believe that the substance can be absorbed and transported through the xylem. When coming into contact with bacteria, by competition, it prevents the disulphide cell-cell and cell-surface bridges from forming and so prevents efficient formation of biofilm. Although preventing biofilm formation, as the dose of N-acetyl L-cysteine (NAC) presented to the bacteria should be much smaller than those tested in vitro probably due to the manner of presentation and translocation, the toxic effect of the substance may have been smaller. Still using the technique of isolation, it was observed that bacterial cells within the plant would likely decrease. Thus, the N-acetyl L-cysteine (NAC) does not kill all cells, which explains the small difference observed in the number of bacteria quantified, and also would not prevent the bacteria from spreading throughout the plant.

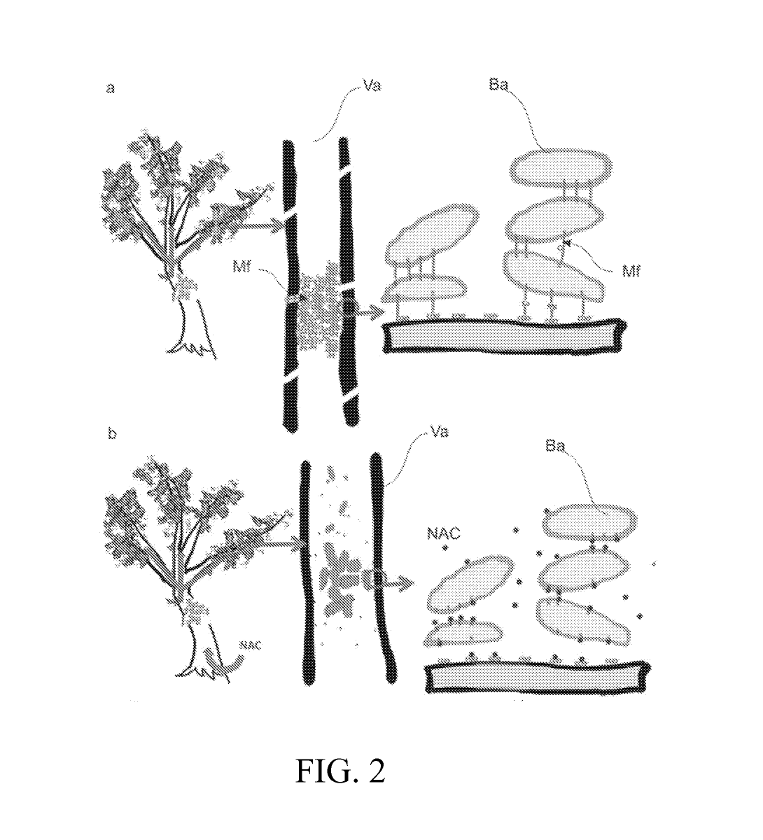

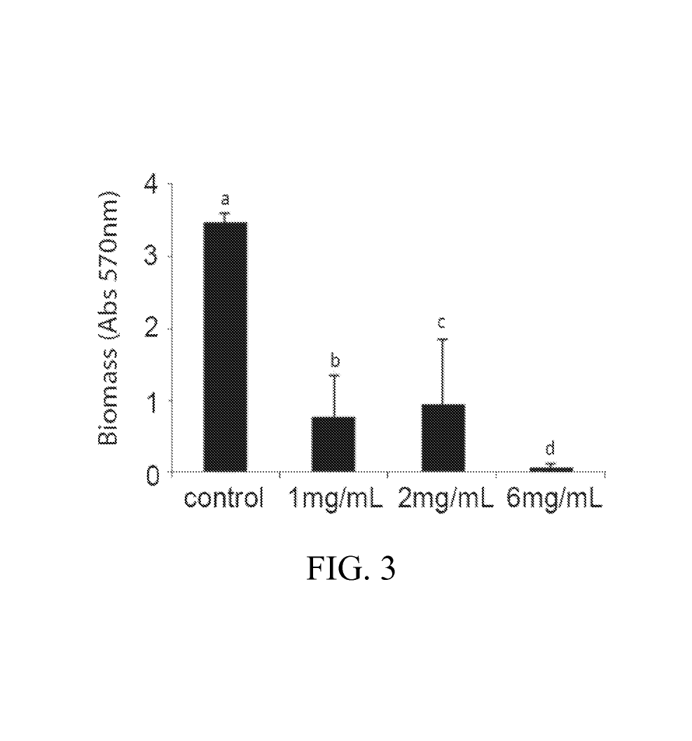

However, as the symptoms have been associated with the obstruction of vessels conducting the biofilm formation does not prevent symptoms appearing, such components illustrated in FIG. 2, where in A, is depicted the evolution of normal mode disease with a blockage of the vessels (Va) of the xylem (X) and the onset of symptoms. The bacteria (Ba) begin a process of joining together and the surface of the xylem (X), with the formation of biofilm (MO being responsible for the obstruction of vessels conducting (Va) and appearance of symptoms.

However, in B, N-acetyl L-cysteine (NAC) operates by avoiding the joining and consequent formation of biofilm (MO. The substance (NAC), by competition, binds to radicals of adherents (fimbrias or afimbrias) and the very xylem (X), not allowing the forming of bridges between adherent bacteria (Ba) to take place and thus avoiding the formation of biofilm (MO. In this way, visible symptoms were not observed or were observed to a lesser degree of severity, avoiding damage to the fruit production of plants of agricultural interest.

In addition, in the proposed model, the action of N-acetyl L-cysteine (NAC) depends on its willingness to destroy the disulphide bonds. So once the presentation of N-acetyl L-cysteine (NAC) is interrupted for the bacteria (Ba), and as many would still be alive, biofilms and symptoms could form again.

When treatment with N-acetyl L-cysteine (NAC) was interrupted during the first two months it was still possible to observe a difference in the number of symptoms presented between the treated and control plants, however after this time we observed the resurgence of symptoms. This time between treatment and disrupting the appearance of new symptoms would be the time that the bacteria would still present in plants to form biofilm and its drivers clog the vessels.

Conclusion of the study: at the end of the experiment and with the analysis and interpretation of the results obtained, it is possible to say the effective efficiency of N-acetyl L-cysteine (NAC) is proven and that it is an analogue of cysteine in the treatment of diseases from psychopathological bacteria, specifically by the fact that significant inhibition was observed in the formation of biofilm.

Further experiments reveal the actual efficacy in the treatment of diseases by substances based on N-acetyl L-cysteine (NAC) in biofilm X. fastidiosa on orange pear plants with symptoms of citrus variegated chlorosis (CVC), regardless of the dose of N-acetyl L-cysteine (NAC) used, because at doses of 1.0, 2.0 or 6.0 mg/mL the compound inhibited biofilm formation and was toxic to the cells of bacteria, since there was wide cell mass decrease and amount of living cells, compared to the control sample (this without the addition of the substance). The experiments in vivo at doses of 120 and 600 mg/ml also showed the action of the substance, providing significant reduction of symptoms in treated plants.

The choice of the analogue of the amino acid cysteine N-acetyl L-cysteine (NAC) as a way of achieving the preferred “compound” or “substance,” object of the study's claims, as well as the ways of achievement for the experiments, “in vitro” and “in vivo” described in this request of invention are provided only as an example. Changes, modifications and variations can be made to any other form in which the “Cysteine amino-acid compound (or its analogues) used in the disruption of microbial biofilms when treating or preventing diseases caused by phytopathogenic bacteria known to attack plants of agricultural interest” by those qualified persons, without, however diverging from the goal shown in the election of this patent, which is uniquely defined by the appended claims.

Within the scope of the previous paragraph it is possible to affirm that it also falling into the inventive concept cysteine amino acid compound (L-cysteine, D-cysteine, DL-cysteine) in inhibiting microbial biofilm formation on plants of industrial interest, all sorts of derivatives of this mucolytic agent, such as esters, amides, anhydrides and thiol-esters, thiol-ethers of the sulfhydryl group of the molecule. Examples include, but are not limited to, methyl-N-acetylcysteine, ethyl N-acetylcysteine, estearil N-acetylcysteine, N-acetylcysteine 20 methiltioéter, N, S-diacetilcisteina, N-acetylcysteine amide, N-mercaptoacetil-L-cysteine, and the mix of N-acetylcysteine anhydride and acetic acid.

Salts of N-acetylcysteine and its derivatives can also be used for disruption of biofilm. Examples of these salts include sodium salts, such as N-acetyl-L-cysteine sodium monohydrate zinc, magnesium, potassium salts, ammonium, and calcium, among others.

It can be affirmed from what has been described and illustrated that the “Cysteine amino-acid compound (or its analogues) used in the disruption of microbial biofilm concerning the treatment or prevention of disease generated by phytopathogenic bacteria that attack plants agricultural interest” hereby claimed applies to the rules governing patents, what has been shown deserving and as a consequence of, their respective privilege.

1. A method of preventing or treating plant disease by preventing formation of a biofilm comprising:
applying an effective amount of a cysteine amino-acid compound or an analog thereof to a plant,
wherein the plant is suffering a disease generated by phytopathogenic bacteria and undergoing a blockage of the xylem (X) vessel (Va) by bacteria (Ba) that adhere to each other and the surface of the xylem (X) forming a biofilm (Mf), and
wherein the compound binds to the adhesive radicals and the actual xylem (X) preventing the formation of bridges between disulphide adhesives of the bacteria (Ba) and thereby prevent formation of a biofilm (Mf) by the bacteria.

2. The method of claim 1, wherein the cysteine amino-acid compound or an analog thereof comprises L-cysteine amino acid.

3. The method of claim 1, wherein the cysteine amino-acid compound or an analog thereof comprises D-cysteine amino-acid.

4. The method of claim 1, wherein the cysteine amino-acid compound or an analog thereof comprises DL-cysteine amino-acid.

5. The method of claim 1, wherein the cysteine amino-acid compound or an analog thereof comprises an analog selected from the group consisting of DL-Homocysteine, L-cysteine methyl ester, L-cysteine ethyl ester, N-carbamoyl cysteine, N-carbamoyl cysteamine, N-(2-mercaptoisobutiril)-L-cysteine, N-(2-mercaptopropionil)-L-cysteine-A, N-(2-mercaptopropionil)-L-cysteine-B, N-(3-mercaptopropionil)-L-cysteine, L-cysteine ethyl ester hydrochloride, L-cysteine methyl ester hydrochloride, nacistelina, N-acetylcysteine (NAC) and S-carbomethyl cysteine (carbocisteine).

6. The method of claim 1, wherein the cysteine amino-acid compound or an analog thereof is non-toxic.

7. The method of claim 1, wherein the cysteine amino-acid compound or an analog thereof is a compound rapidly absorbed into an environment.

8. The method of claim 1, wherein the cysteine amino-acid compound or an analog thereof further comprises zinc or copper.

9. The method of claim 1, wherein the cysteine amino-acid compound or an analog is applied using fertilizer-irrigation or inundation of a small area next to the plant.

10. The method of claim 1, wherein the cysteine amino-acid compound or an analog is applied in a slow-release capsule form.

11. The method of claim 1, wherein the disease is at least one of citrus canker, citrus variegated chlorosis (CVC), huanglongbing (HLB) disease, and Pierce's disease.

12. The method of claim 1, wherein the disease is caused by at least one of Xanthomonas citri, Xylella fastidiosa, X. fastidiosa.

13. The method of claim 12, wherein the disease is caused by Xanthomonas citri.
